(19) United States
(12) Patent Application Publication
(10) Pub. No.: US 2012/0031895 A1
(43) Pub. Date: Feb. 9, 2012

(54) SOLDERING HEAD AND PROCESS FOR INDUCTIVE SOLDERING

(76) Inventors: Antal Makacs, GroBschwabhausen (DE); Roland Weidl, Bollberg (DE)

(21) Appl. No.: 13/186,061

(22) Filed: Jul. 19, 2011

(30) Foreign Application Priority Data
Aug. 4, 2010 (DE) 102010033361.1-24

(51) Int. Cl. B23K 1/002; H05B 6/14; B23K 3/00

(52) U.S. Cl. 219/616; 219/673

(57) ABSTRACT

A soldering head for an induction-soldering apparatus for soldering a contact strip onto a solar cell and a soldering process using the soldering head are provided. The soldering head has a soldering side, with which the soldering head is placed onto the site to be soldered during the soldering process, an inductor loop with a feed region and a coupling-out region arranged on the soldering side, a main body made of an electrically non-conductive material, and a fastener, with which the main body is fixed to the inductor loop, wherein the coupling-out region of the inductor loop is exposed on the soldering side, and the main body has one or more spacer elements, on the soldering side, which are arranged outside the coupling-out region and protrude beyond the coupling-out region of the inductor loop.

### CROSS REFERENCE TO RELATED APPLICATIONS

This application claims benefit under 35 U.S.C. §119(a) of German Patent Application No. 10 2010 033 361.1-24, filed Aug. 4, 2010, the entire contents of which are incorporated herein by reference.

### BACKGROUND OF THE INVENTION

1. Field of the Invention

The present invention relates to a soldering head for an apparatus for inductive soldering and also to a process for soldering a contact strip.

2. Description of Related Art

In the production of thin-film solar modules, the production of the so-called raw module, which comprises the substrate, the photovoltaic layer system and the back electrode layer, is followed by the establishment of the electrical contact connection, wherein the back electrode layer of the so-called tapping cells of the thin-film solar module is generally contact-connected by two or more metallic connection strips, which conduct the current produced away. High demands are placed on the electrical contact connection made by the metallic connection strips, since the thin-film solar module in subsequent use in outdoor areas may be exposed to strong temperature fluctuations and weathering influences over a long period of time of at least 20 years and should operate without the need for maintenance in this time.

The metallic connection strips may firstly be fastened to the back electrode layer by adhesive bonding using a conductive adhesive, but they are preferably fastened thereto by a soldered connection, since generally the adhesive bonding processes do not achieve sufficient long-term stability of the connection.

A soldered connection of the metallic connection strips generally allows for a more reliable contact connection with improved long-term stability; however, there is the risk, particularly in the case of thin-film solar modules, that the back electrode layer and the underlying photovoltaic layer system, which only has a thickness of a few μm, will be thermally damaged by the soldering process. In particular, instances of so-called “through-soldering” may occur, which are visible on the front side of the thin-film module and represent an optical defect and lead to rejects. However, through-soldering may also bring about an electrical short circuit of the front electrode layer and back electrode layer, which reduces the performance of the thin-film module. If the soldering power and/or the soldering duration and therefore the amount of energy introduced are reduced to avoid instances of thermal damage, this may result in a cold soldering site, and this does not establish a permanently stable mechanical strength or a permanently secure contact. Since the overall layer structure of a thin-film module normally only has a thickness of about 2 to 10 μm, the back contact has only a very small heat capacity, and therefore even small fluctuations in the soldering process have a serious effect on the soldering result. The soldering of metallic connection strips onto a raw module therefore places extremely high demands on the stability and the reproducibility of the soldering process.

Furthermore, high demands are placed on the speed of the soldering process. Each soldering strip is fastened to the thin-film solar module with a number of, typically 20, spot joints, depending on the size of the module. In order to achieve acceptable overall soldering times per module, an individual joint should not take longer than one second.

In addition to the conventional contact soldering, in which the heat is introduced convectively by a soldering tip, contactless inductive soldering processes are already known from the prior art, wherein the energy for melting the solder in this case is fed to the soldering site by an electromagnetic high-frequency field, which heats the soldering site by virtue of the currents induced. The prior art describes an inductive soldering process for the electrical contact connection of solar cells, for example, in EP 2103373 A1, where in this case crystalline solar cells on the basis of an Si wafer are contact-connected rather than thin-film solar cells. The inductor loop here has a U-shaped form with undulating limbs. A plurality of sites can be soldered in parallel. During the soldering process, the metallic connection strip to be soldered is pressed onto the solar cell via holding-down means.

A further inductive soldering process for solar cells is disclosed in EP 1748495 A1, wherein in one embodiment the inductor is simultaneously formed as a movable holding-down means, which, during the soldering process, is placed onto the soldering site. In one embodiment, a small thermal insulation plate having a thickness of preferably 2 mm is arranged between the inductor and the metallic soldering strip.

A further inductive soldering process for solar cells is described in DE 10335438 B4, wherein here the inductor is likewise formed as a holding-down means, and wherein a pressing force is applied to the soldering site by way of a pressure-exerting plate, which is located between the inductor loop and the soldering site.

However, the apparatuses and processes from the prior art are not suitable for the inductive soldering of metallic connection strips onto thin-film solar modules. If the induction coil is freely suspended without being fixed in relation to the soldering site, it is generally the case that a stable result of the soldering process is not achieved, since it is not possible to observe a uniform spacing from the soldering site. If, by contrast, there is a holding-down means between the inductor loop and the soldering site, the spacing between the induction coil and the soldering site is likewise changed by wear and contamination of the holding-down means, for example by accumulations of evaporating flux, and therefore a stable soldering process is not achieved.

### BRIEF SUMMARY OF THE INVENTION

The object of the invention is therefore that of providing a soldering head for an induction-soldering apparatus for inductively soldering a metallic contact strip onto a thin-film solar module, which ensures a reliable mechanical and electrical soldered connection without however damaging the semiconductor layer and the front electrode, and which ensures a quick and reproducible soldering process which is stable in continuous operation. The object is also that of providing a process for soldering metallic contact strips onto thin-film solar modules.

The soldering head according to the invention for an induction-soldering apparatus comprises a soldering side, with which the soldering head is placed onto the site to be soldered during the soldering process, an inductor loop with a feed region and a coupling-out region arranged on the soldering side, a main body made of an electrically non-conductive material, and a fastening means, with which the main body is fixed to the inductor loop, characterized in that the coupling-out region of the inductor loop is exposed on the soldering side, and in that the main body has one or more spacer elements, on the soldering side, which are arranged outside the coupling-out region and protrude beyond the coupling-out region of the inductor loop.

The inventors have realized that the spacing between the coupling-out region of the inductor loop and the surface of the specimen to be soldered has to be observed very precisely for an inductive soldering process, which should ensure reliable, electrical contact connection, without damaging the semiconductor layer and the front electrode, and which should ensure a quick and reproducible soldering process which is stable in continuous operation; this is not ensured in the case of the soldering heads according to the prior art. If the soldering head according to the invention is placed with the soldering side onto the site to be soldered, contact is established with the surface of the specimen to be soldered by the spacer element(s) arranged on the soldering side outside the coupling-out region, as a result of which a very precise spacing is established between the coupling-out region of the inductor loop and the surface of the specimen to be soldered. According to the invention, the inductor loop is exposed in the coupling-out region, i.e. there is no contact material between the coupling-out region of the induction loop and the soldering site which is placed onto the soldering site in the soldering phase. This firstly has the advantage that such a contact material also does not have to be concomitantly heated and thus a maximum amount of energy is introduced into the site to be soldered. Secondly, however, it is also the case that wear phenomena cannot arise on such a contact material, which is exposed to very high thermal and mechanical loading and also contamination by evaporating flux. Furthermore, an undefined quantity of heat can be taken from the soldering site by a contact material between the coupling-out region and the soldering site, since the transfer of heat between the soldering site and the contact material is dependent, for example, on the contact pressure and also on the state of contamination of the contact material with flux. The soldering head according to the invention, by contrast, has one or more spacer elements, which are arranged outside the coupling-out region and are therefore placed onto the solar cell outside the site to be soldered. The spacer element(s) is/are therefore subjected to considerably less thermal loading and is/are also not exposed to any contamination by evaporating flux. Therefore, wear to the spacer elements is also reduced and it is possible to concomitantly establish a permanently stable spacing between the coupling-out region of the inductor loop and the surface of the specimen to be soldered. Since the inductor loop is exposed only over a small length in the coupling-out region, it is advantageously possible to avoid problems resulting from vibrations or thermal deformation of the inductor loop, which likewise lead to an unstable soldering process.

The soldering head according to the invention can be used in conjunction with an induction-soldering apparatus, which generally comprises a medium-frequency or a high-frequency power source and also a coolant supply. Furthermore, the induction-soldering apparatus generally comprises a reception apparatus for the soldering head, which is arranged on a mechanical displacement unit such that the soldering head can be moved into the region of the soldering site and can be placed thereon. In order to avoid damage to the site to be soldered, provision is advantageously also made of means which ensure that the soldering head is placed quickly, but in a controlled manner, onto the site to be soldered.

The soldering side of the soldering head is generally to be understood as meaning that side of the soldering head on which the coupling-out region of the inductor loop is arranged. According to the invention, the soldering head is placed with this soldering side onto the site to be soldered, such that energy is inductively introduced into the site to be soldered by the inductor loop in the coupling-out region.

The inductor loop has a feed region which supplies the medium frequency or high frequency to the coupling-out region. In this feed region, the inductor loop is guided in the direction of the soldering side and generally has two parallel limbs, such that as far as possible no coil effect is present and as little energy as possible is radiated. The inductor loop can be supplied directly to the soldering side in the feed region, i.e. can extend perpendicularly to the soldering side, or else can also be led to the soldering side obliquely.

On the soldering side, the inductor loop forms the coupling-out region. In this region, the inductor loop can have half a turn, a whole turn or else a plurality of turns, which are intended for coupling out the medium frequency or high frequency. To this end, certain portions of the coupling-out region of the inductor loop can extend parallel to the soldering side on the soldering side of the soldering head.

However, one or more spacer elements protrude beyond the inductor loop on the soldering side, such that the soldering head, when it is placed on a planar surface, only rests on the surface by way of the spacer elements and the inductor coil has no contact with the surface to be soldered but instead is at a small spacing therefrom.

The main body consists of an electrically non-conductive material and, on the soldering side, has one or preferably more spacer elements, which, according to the invention, are arranged outside the coupling-out region. By way of example, a spacer element may simply have a pin- or bar-shaped design, and may have a punctiform or flat placement region. Similarly, one or more spacer elements can extend around the coupling-out region and partially or completely enclose the latter. By way of example, the main body may be formed in one piece with the spacer elements. However, the spacer elements can also be fastened detachably to the main body and consist of the same or a different material. Similarly, the connection between the spacer elements and the main body can be made adjustable, for example by the spacer elements being formed by elements which can be screwed in, such that the effective length of the spacer elements can be adjusted. The main body may have recesses for receiving both the feed region and the coupling-out region of the inductor loop. According to the invention, the inductor coil is exposed on the coupling-out side in the coupling-out region and is not encompassed by the main body.

According to the invention, the main body is fastened to the inductor loop with a fastening means. The fastening can be effected in the coupling-out region of the inductor loop, but is preferably effected in the feed region. By way of example, the fastening means can comprise a plate and screws, with which the main body is clamped to the feed region of the inductor loop, such that a detachable and adjustable connection is present. The main body can likewise be fastened to the inductor loop by adhesive bonding or other means. An inductive soldering head generally also comprises a flange for coupling the soldering head to an induction-soldering apparatus. The main body can alternatively also be fastened to this flange, which in this sense is to be counted as part of the feed region of the inductor loop.

In a first preferred embodiment, the inductor loop has a U-shaped basic form and has at least a first bend in the two limbs which separates the feed region and the coupling-out region, wherein the two limbs extend parallel to one another in the direction of the soldering side in the feed region and likewise extend parallel to one another and parallel to the soldering side in the coupling-out region. In this form, the inductor loop therefore has only a U-shaped half turn, wherein the feed region is formed by two parallel limbs and the limbs, in the region of the soldering side, have a common bend and then extend parallel to one another and approximately parallel to the soldering side.

In a further preferred embodiment, the inductor loop has a second bend which terminates the coupling-out zone, wherein the two limbs, in the adjoining region, firstly extend parallel to one another leading away from the soldering side and, in an adjoining region, form a substantially semicircular termination of the inductor loop. This form provides a particularly homogeneous field distribution of the site to be soldered in the region of the coupling-out zone which is largely unaffected by the termination of the inductor loop, in that the termination of the induction loop is not in the region of the soldering side.

In a further preferred embodiment, the main body has at least two spacer elements, which are arranged on the soldering side on both sides of the coupling-out region.

In a further preferred embodiment, the spacer elements define a placement plane on the soldering side, wherein the spacing between the inductor loop and the placement plane in the coupling-out region is between 0.1 mm and 2 mm. The placement plane here can be defined, for example, by a single spacer element with a flat placement region or else a plurality of spacer elements. With respect to the spacing, it should be taken into consideration that the energy cannot be introduced efficiently if the spacing is too large. If the spacing is too small, there is the risk that the inductor loop will make contact with the soldering site, as a result of which the inductor loop can undergo a loss of adjustment or can be bent. A spacing between the inductor loop and the placement plane in the coupling-out region of between 0.1 mm and 2 mm makes it possible to achieve an optimum introduction of energy into the soldering site and to achieve an optimum soldering result. The spacing between the inductor loop and the placement plane is preferably 0.2 mm to 0.5 mm.

In a further preferred embodiment, the main body has a multi-part design, wherein a first part in the feed region is fixed by way of the fastening means to the inductor loop, and a second part comprises the spacer element(s), and wherein means for the relative positioning of the first part and of the second part are also present, as a result of which the spacing between the inductor loop and the placement plane is variably adjustable. The first part of the main body is preferably fastened to the inductor loop in the feed region. In the simplest case, the second part of the main body can comprise merely the spacer element, for example. By way of example, this may involve a screw-like element which is screwed into the first part of the main body, as a result of which the actually effective length of the spacer element and therefore the spacing between the inductor loop and the placement plane are variably adjustable. Similarly, however, the second part of the main body can also comprise a plurality of spacer elements and may be positionable as an overall unit in relation to the first part of the main body.

In a further preferred embodiment, the inductor loop consists of a silver-plated or gold-plated copper pipe, which can be cooled by a cooling liquid. On account of the skin effect, the conductivity of the inductor coil can be raised considerably by the precious metal coating. The inductor loop can be cooled, for example, using water as the cooling liquid.

In a further preferred embodiment, the soldering head has a flange, via which a detachable connection can be established between the inductor coil and a high-frequency generator or a medium-frequency generator and also the coolant supply. As a result, the soldering head can easily be assembled and disassembled.

In a further preferred embodiment, the main body consists at least partially of a fibre-reinforced plastic which can withstand high temperatures. The main body is exposed to high mechanical and thermal loading. In particular, the main body must undergo only little abrasion given frequent placement and has to consist of an electrically non-conductive material, so that it is not heated by the electromagnetic field and also does not have a disruptive influence on the latter. Optimum continuous operation which does not require maintenance has been achieved with a main body consisting of a fibre-reinforced plastic which can withstand high temperatures and satisfies the properties required outstandingly.

The invention also comprises a process for soldering a contact strip onto the electrode layer of a solar cell, the process according to the invention comprising the following process steps: the provision of the solar cell and of the contact strip, the positioning of the contact strip on the site to be soldered, the placement of the soldering head, a soldering phase, in which the soldering region is inductively heated and soldered, a cooling phase, in which the solder solidifies, and the withdrawal of the soldering head.

In the first step, the solar cell and the contact strip are provided. By way of example, the solar cell can be a crystalline solar cell on the basis of a semiconductor wafer. The text which follows describes, by way of example, the case of the raw module of a thin-film solar cell having a back electrode layer on the rear side. A raw module is generally divided by dividing lines into partial cells connected in series. Furthermore, a specific number of partial cells connected in series are generally interconnected in each case to form a partial module, i.e. the contact strip is soldered in each case onto the first and the last cell of a partial module with the contact strip. By way of example, the contact strip can be a thin copper strip, which is generally pre-tin-plated with a solder. The site to be soldered on the contact strip is generally also provided with flux. In a second process step, the contact strip is positioned along the tapping cells. In a third process step, the soldering head is placed onto the site to be soldered. After the soldering head has been set down, the soldering region is inductively heated in the actual soldering phase, such that the solder is melted and a soldered connection is established between the contact strip and the back electrode layer. This is followed by a cooling phase, in which less or no more alternating current is supplied to the soldering head, so that the soldering site is cooled and the solder solidifies. The soldering head is then withdrawn. The contact ribbon is generally fastened to the back electrode layer in the manner described typically at 10 to 20 or more soldering points, which are arranged uniformly over the length of the tapping cells. Similarly, two respective soldering points can be provided directly alongside one another, in order to provide redundancy for the failure of a soldering site. Therefore, the process described does not provide a continuous soldered connection between the contact ribbon and the back electrode layer.

In a first preferred embodiment of the process, the soldering head has at least two spacer elements on both sides of the coupling-out region and is placed onto the contact strip by way of at least two spacer elements on both sides of the soldering region, such that the contact strip is held down on both sides of the soldering region in the soldering phase. In this preferred embodiment, the spacer elements thus simultaneously serve as means for holding down the contact strip.

In a further preferred embodiment of the process, the spacing between the inductor loop and the contact strip is between 0.1 mm and 1 mm, preferably between 0.2 mm and 0.5 mm.

In a further preferred embodiment of the process, a constant power is inductively introduced for a period of time of 0.2 s to 2 s immediately after placement of the soldering head, and the soldering head is raised immediately after the introduction of energy has been completed. It has surprisingly been found that it is possible to dispense with a cooling phase entirely if the soldering time is appropriate, i.e. the inductively introduced power is shut off and at the same time the soldering head is raised after the soldering phase lasting for a predefined period of time has been completed.

In a further preferred embodiment of the process, a power of 1 kW to 5 kW and a frequency from the range of 0.1 MHz to 10 MHz is supplied to the soldering head in the soldering phase.

In a further preferred embodiment of the process, no step for preheating the solar cell is effected. Whereas a step for preheating the solar cell is often provided in soldering processes from the prior art in order to reduce the soldering time, the process according to the invention can be effected without the solar cell being preheated. This means that the solar cell can substantially be at ambient temperature before the soldering process in the process according to the invention.

In a further preferred embodiment of the process, the contact strip is a tin-plated copper strip having a width of 0.5 mm to 10 mm and a thickness of 50 μm to 500 μm.

In a further preferred embodiment of the process, the copper strip is tin-plated with a solder having a Pb content of less than 0.1% by weight Pb with a layer thickness of 5 μm to 50 μm. Low-lead or lead-free solders containing less than 0.1% by weight Pb are generally distinguished by higher melting temperatures and also poorer flow properties. With the process according to the invention, it is surprisingly also possible to successfully solder not only contact strips with lead-containing standard solders, but also contact strips with solders having a Pb content of less than 0.1% by weight Pb onto a back electrode layer of a thin-film raw module. It goes without saying that the process can likewise be used successfully for a soldering process with a Pb content of more than 0.1% by weight Pb.

In a further preferred embodiment of the process, the solar cell is a thin-film solar cell, preferably an Si-based thin-film solar cell. In this context, a thin-film solar cell is to be understood as meaning a raw module which, in particular, still has no rear-side encapsulation.

In a further preferred embodiment of the process, the layer system on the rear side of the thin-film solar cell has an Ag-, Al- or Cu-containing reflector layer having a layer thickness of 100 nm to 1 μm, and also an Sn-, Cu- or Ag-containing contact layer having a layer thickness of 10 nm to 200 nm. Here, the Ag-, Al- or Cu-containing reflector layer acts firstly as a reflector but also as the back electrode layer of the thin-film solar cell. Ag, Al and Cu are distinguished by the high reflection required and also electrical conductivity. The reflector layer can likewise comprise a plurality of individual Ag-, Al- or Cu-containing layers. The contact layer finally represents a solderable layer onto which the contact ribbon can be soldered.

In a further preferred embodiment of the process, no further layer is arranged between the reflector layer and the contact layer. In general, it is also possible for a barrier layer having a thickness of 2 nm to 500 nm to be arranged between the Ag-, Al- or Cu-containing reflector layer and the contact layer. The barrier layer is formed from a metallic alloy, which does not alloy with the contact layer or the reflector layer. It contributes to the avoidance of instances of through-soldering and prevents the reflector from becoming damaged during the soldering process. By way of example, it can consist of an NiV alloy. Surprisingly, however, it is possible to dispense with a barrier layer with the soldering process according to the invention, and no instances of through-soldering occur even without a barrier layer.

In a further preferred embodiment of the process, the solar cell is a crystalline solar cell on the basis of a semiconductor wafer. Crystalline solar cells on the basis of a semiconductor wafer generally have a flat back electrode layer and a front electrode which is not flat imprinted on the front side. If a plurality of such solar cells are interconnected, a plurality of solar cells are in each case interconnected in series to form partial modules, wherein the rear side of a solar cell is connected in each case to the front side of the next solar cell by a contact strip. With the process according to the invention, the contact strip can be placed both on the front side of a solar cell on the basis of a semiconductor wafer and on the rear side thereof.

In the text which follows, the invention is explained with reference to exemplary embodiments, which are shown schematically in the figures.

### BRIEF DESCRIPTION OF THE SEVERAL VIEWS OF THE DRAWINGS

FIG. 1: is a sectional diagram of a soldering head according to the invention placed perpendicular to the contact ribbon,

FIG. 2: is a view from the front of a soldering head according to the invention placed parallel to the contact ribbon, and

FIG. 3: is a perspective view of a soldering head according to the invention with a flange.

### DETAILED DESCRIPTION OF THE INVENTION

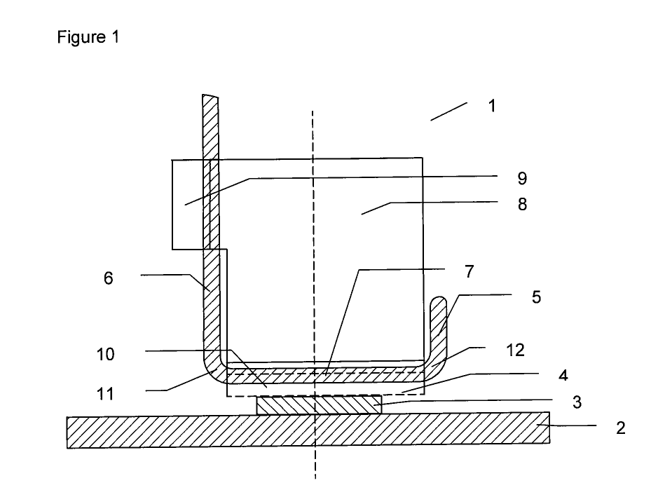

FIG. 1 is a sectional diagram of a soldering head (1) according to the invention, which is placed by way of a spacer element (10), which is located on the soldering side (4) of the soldering head (1), onto a contact ribbon (3), which lies on a solar cell (2). The soldering head comprises a U-shaped inductor loop (5), which is divided by a first bend (11) and a second bend (12) into a feed region (6), a coupling-out region (7) and finally an end region. The soldering head also comprises a main body (8), which is fastened to the feed region (6) of the inductor loop (5) via fastening means (9). FIG. 1 shows the case in which the soldering head (1) is set down on the contact ribbon by way of the spacer elements (10) and the spacer elements hold down the contact ribbon.

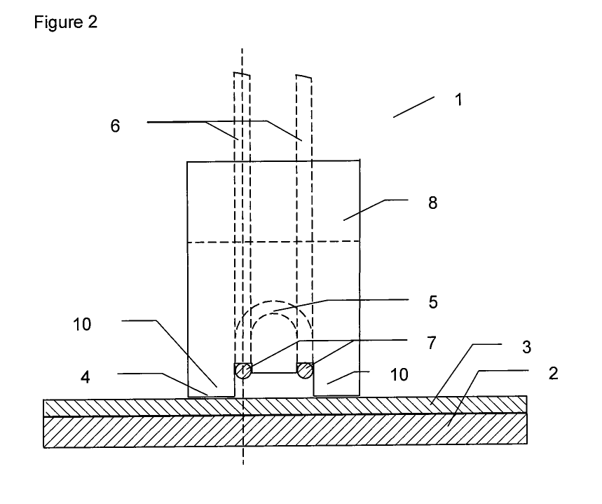

FIG. 2 is a further sectional diagram of the soldering head from FIG. 1, in the sectional plane shown in FIG. 1. In this section, in addition to the elements already described in FIG. 1, it is possible to clearly identify the spacer elements (10) arranged on both sides of the coupling-out region (7), the feed region (6) and also the end region of the inductor loop (5), in which the inductor coil is closed. In the soldering head shown, the main body (8) is formed in one piece with the spacer elements (10) and, on the soldering side (4), which faces towards the solar cell (2), has depressions, which are suitable for receiving the coupling-out region (7) of the inductor loop (5).

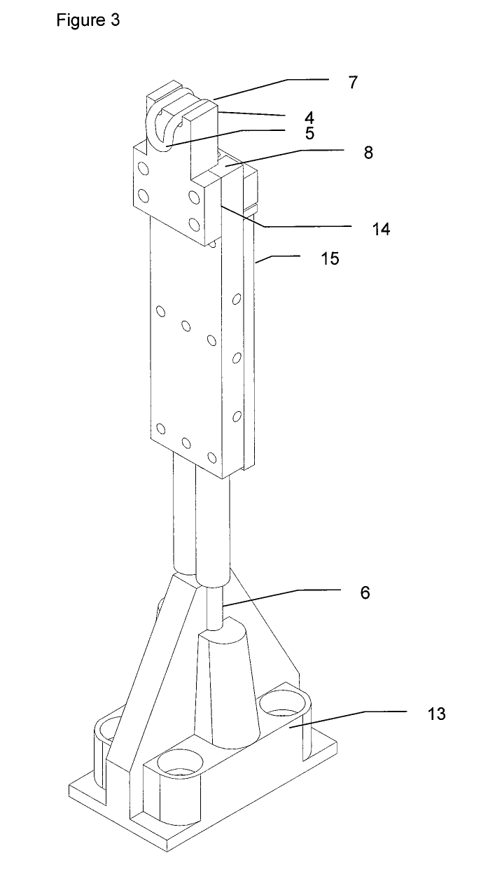

FIG. 3 is a perspective view of a soldering head (1) according to the invention, including a flange (13) for detachable coupling to an induction-soldering apparatus. In the embodiment shown, the main body (8) has a multi-part design and is fastened with a first part (15) to the feed region of the inductor loop (6), whereas a second part (14) is arranged such that it can move in relation to said first part. The parts (14) and (15) can be connected to one another in the manner of a slide, for example, i.e. by a one-dimensional displacement unit, wherein the precise relative position can be adjusted precisely by set screws. However, the parts (14, 15) can likewise be connected to one another by one or more screwed connections, where one part has elongated holes which ensure one-dimensional displaceability. The spacer elements (10) are formed in one piece with the part (14) of the main body, such that the spacing of the inductor loop (7) in relation to the soldering plane defined by the spacer elements can be varied by the relative adjustment of the parts (14, 15) in the coupling-out region. In the example shown, the part (14) of the main body is furthermore likewise formed in two parts for design reasons, although these two parts are fixedly connected to one another.

The soldering head according to the invention and the soldering process according to the invention provide a soldering head for an induction-soldering apparatus for inductively soldering a metallic contact strip onto a thin-film solar module, which ensures a reliable mechanical and electrical soldered connection without however damaging the semiconductor layer and the front electrode, and which ensures a quick and reproducible soldering process which is stable in continuous operation.

A soldering head according to the invention was successfully used, for example, for soldering tin-plated copper contact strips having a thickness of 50 μm to 500 μm and a width of 2 mm to 5 mm onto amorphous Si thin-film raw modules. The thin-film raw modules had a back electrode structure which, in addition to an Ag reflector layer, has an NiV layer, which additionally counteracts instances of through-soldering. HF generators having a frequency of 800 kHz and a power of about 2 kW were used. With the inductor coil at a spacing from the contact strips of about 0.4 mm, very short soldering times of 0.5 seconds were achieved. It has been possible to reliably avoid instances of through-soldering as well as defective soldering sites on the present system after appropriate optimization of the soldering times.

With soldering heads according to the prior art, however, instances of through-soldering and also “cold” soldering sites which cannot be subjected to loading repeatedly arose even with relatively high soldering times of more than one second, and therefore the process stability required has not been achieved.

As a measure of the quality of the joint, a tear-off test was carried out, in which the contact strip soldered on one side was torn off perpendicularly from the solar cell and the force at which the soldering site failed was determined. Based on experience, a tear-off force of at least 2 N is required to ensure that there is sufficiently good electrical contact and the contact ribbon cannot tear off a rear side when it is laminated on. The tear-off forces with the soldering process according to the invention were approximately in the region of 10 N with a small fluctuation margin and stable above 5 N. An analysis of the small strips torn off showed that the failure often took place not through the soldering site but within the layer system, i.e. the soldering site has a greater strength than the layer system. The soldering head was able to be used in continuous operation without problems relating to wear and contamination arising.

When using an inductive soldering head from the prior art, which, like the soldering head according to the invention, has an inductor loop and is placed on the contact strip by way of a thin, small ceramic plate, it has been possible to achieve merely soldering times of 1.2 to 1.4 seconds by comparison given otherwise identical conditions in terms of the soldering apparatus and the contact strip/solar cell system to be soldered. It was not possible to reliably avoid instances of through-soldering. Furthermore, the soldering head had a much shorter service life.

It goes without saying that a plurality of soldering heads according to the invention can also be used in one apparatus, such that in each case a plurality of soldering sites can be soldered in parallel. By way of example, at least two contact strips which extend parallel to one another are soldered onto a raw module of a thin-film solar cell. Each contact strip is fastened to the back electrode by a number of, about 20, spot joints. By way of example, one soldering head is preferably assigned to each contact strip.

The soldering process according to the invention can be used not only for soldering the contact ribbons onto the back electrode layer of a thin-film solar cell, as a result of which in each case the first and the last partial cell of a partial module are contact-connected, but also for soldering the so-called cross connectors onto the contact ribbons, which are already soldered onto the thin-film solar cell. The soldering of the cross connectors for the parallel interconnection of the partial modules of a thin-film solar module is necessary if the thin-film solar module is divided electrically into a plurality of partial modules. The cross connectors preferably have the same design as the contact strips and consist, for example, of a tin-plated small copper strip. In order to be soldered to the contact ribbons, the cross connectors are positioned on the latter, and the soldering head according to the invention is placed on by way of the protruding spacer elements such that the cross connector is held down on the contact ribbon. The actual soldering process can then take place, in which the HF energy is supplied to the soldering head and the cross connector is soldered to the contact ribbon. The cross connectors can be soldered to a contact ribbon both in a region in which the latter is already soldered to the back electrode layer and in a region in which the contact ribbon is not soldered to the back electrode layer.

### LIST OF REFERENCE NUMERALS

1 Soldering head
2 Solar cell
3 Contact strip
4 Soldering side
5 Inductor loop
6 Feed region of the inductor loop
7 Coupling-out region of the inductor loop
8 Main body
9 Fastening means
10 Spacer element
11 First bend in the inductor loop
12 Second bend in the inductor loop
13 Flange
14 Part of the main body
15 Further part of the main body

What is claimed is:

1. A soldering head for an induction-soldering apparatus, comprising:
a soldering side, with which the soldering head is placed onto the site to be soldered;
an inductor loop with a feed region and a coupling-out region, the coupling-out region being arranged on the soldering side;
a main body made of an electrically non-conductive material; and
a fastener affixing the main body to the inductor loop,
wherein the coupling-out region is exposed on the soldering side, and
wherein the main body has one or more spacer elements, on the soldering side, which are arranged outside the coupling-out region and protrude beyond the coupling-out region.

2. The soldering head according to claim 1, wherein the inductor loop has a U-shaped basic form and has at least a first bend in two limbs which separate the feed region and the coupling-out region, wherein the two limbs extend parallel to one another in the direction of the soldering side in the feed region and likewise extend parallel to one another and parallel to the soldering side in the coupling-out region.

3. The soldering head according to claim 2, wherein the inductor loop has a second bend which terminates the coupling-out zone, wherein the two limbs, in an adjoining region, firstly extend parallel to one another leading away from the soldering side and, in the adjoining region, form a semicircular termination of the inductor loop.

4. The soldering head according to claim 1, wherein the main body has at least two spacer elements, which are arranged on the soldering side on both sides of the coupling-out region.

5. The soldering head according to claim 4, wherein the at least two spacer elements define a placement plane on the soldering side, and wherein the inductor loop and the placement plane having a spacing therebetween in the coupling-out region that is between 0.1 mm and 2 mm.

6. The soldering head according to claim 5, wherein the main body has a multi-part design, having a first part in the feed region that is fixed by the fastener to the inductor loop and a second part that comprises the at least two spacer element.

7. The soldering head according to claim 6, further comprising a device configured to change the relative position of the first part and of the second part so that the spacing between the inductor loop and the placement plane is variably adjustable.

8. The soldering head according to claim 1, wherein the inductor loop consists of a silver-plated or gold-plated copper pipe, which can be cooled by a cooling liquid.

9. The soldering head according to claim 1, wherein the soldering head has a flange, via which a detachable connection can be established between the inductor coil and a high-frequency generator and also the coolant supply.

10. The soldering head according to claim 1, wherein the main body consists at least partially of a fibre-reinforced plastic which can withstand high temperatures.

11. A process for soldering a contact strip onto a solar cell, the process comprising:
positioning of the contact strip on a site of the solar cell to be soldered;
placing a soldering side of a soldering head is placed onto the site so that a coupling-out region of an inductor loop is exposed on the soldering side and so that has one or more spacer elements, on the soldering side, which are arranged outside the coupling-out region and protrude beyond the coupling-out region face the site,
inductively heating the contact strip at the site;
solidifying the solder; and
withdrawing of the soldering head from the site.

12. The process according to claim 11, wherein the soldering head has at least two spacer elements on both sides of the coupling-out region and is placed onto the contact strip by way of the spacer elements, such that the contact strip is held down on both sides of the soldering region.

13. The process according to claim 11, wherein the inductor loop and the contact strip have a spacing therebetween of between 0.1 mm and 1 mm.

14. The process according to claim 11, wherein the inductor loop and the contact strip have a spacing therebetween of between 0.2 mm and 0.5 mm.

15. The process according to claim 11, wherein the inductively heating, solidifying, and withdrawing steps comprise introducing a constant HF power for a period of time of 0.2 seconds to 2 seconds immediately after placing the soldering head and raising the soldering head immediately after the introduction of energy has been completed.

16. The process according to claim 11, wherein the inductively heating step comprises supplying HF energy having a power of 1 kW to 5 kW and at a frequency from the range of 0.1 MHz to 10 MHz to the soldering head.

17. The process according to claim 11, wherein no step for preheating the solar cell is required.

18. The process according to claim 11, wherein the contact strip is a tin-plated copper strip having a width of 0.5 mm to 10.0 mm and a thickness of 50 μm to 500 μm.

19. The process according to claim 11, wherein the copper strip is tin-plated with a solder having a Pb content of less than 0.1% by weight Pb with a layer thickness of 5 μm to 50 μm.

20. The process according to claim 11, wherein the solar cell is a thin-film solar cell.

21. The process according to claim 11, wherein the solar cell is an Si-based thin-film solar cell.

22. The process according to claim 11, wherein the solar cell has a layer system on a rear side comprising an Ag-, Al- or Cu-containing reflector layer having a layer thickness of 100 nm to 1 μm and an Sn-, Cu- or Ag-containing contact layer having a layer thickness of 10 nm to 200 nm.

23. The process according to claim 22, comprising no layer arranged between the reflector layer and the contact layer.

24. The process according to claim 11, wherein the solar cell is a crystalline Si solar cell based on a semiconductor wafer.
